(19) United States
(12) Patent Application Publication
(10) Pub. No.: US 2020/0303987 A1
(43) Pub. Date: Sep. 24, 2020

(54) ELECTRIC MACHINE, AND METHOD FOR PRODUCING AN ELECTRIC MACHINE

(71) Applicant: Robert Bosch GmbH, Stuttgart (DE)

(72) Inventors: Armin Stubner, Buehl-Altschweier (DE); Christian Meyer, Karlsruhe-Wolfartsweier (DE); Torsten Gmuend, Rastatt-Pliitersdorf (DE); Hans-Peter Dommsch, Lichtenau (DE); Jean-Marc Ritt, Strasbourg (FR)

(21) Appl. No.: 16/087,777

(22) PCT Filed: Mar. 16, 2017
(86) PCT No.: PCT/EP2017/056248

§ 371 Date: Sep. 24, 2018

(30) Foreign Application Priority Data
Mar. 24, 2016 (DE) 10 2016 204 968.2

(51) Int. Cl. H02K 5/22; H01R 13/52; H01R 43/00; H02K 5/10; H02K 5/15; H02K 11/22; H02K 11/215; H02K 15/14

(52) U.S. Cl. CPC H02K 5/225; H01R 13/5202; H01R 13/5213; H01R 43/005; H02K 15/14; H02K 5/15; H02K 11/022; H02K 11/215; H02K 5/10

(57) ABSTRACT

The invention relates to an electric machine (10), in particular an electronically commutated EC motor, and a method for producing same, comprising a pole-well (15) in which a stator (16) and a rotor (18) are accommodated, and a plug housing (33) having an integrated connection plug (37) is arranged axially on the open side of the pole-well (15), wherein the plug housing (33) is surrounded by a metal cover (81) over its entire circumference, which is sealingly connected to the pole-well (15), wherein the connection plug (37) projects outwards through a recess (39) in the metal cover (81) in a direction axially opposing the rotor (18), and the plug housing (33) is sealed against the metal cover (81) by means of a sealing ring (84).

### BACKGROUND OF THE INVENTION

The invention relates to an electrical machine, and to a method for producing such an electrical machine.

An electrical machine is known from DE 10 2011 084 763 A1, in which a stator is arranged in a pole pot. A cover part is arranged on the pole pot, in which a rotor shaft is supported. The cover part is formed of plastic, and comprises electrical conductor elements for the interconnection of the electric winding of the stator. The coil wire ends of the windings are routed axially through the cover part, and are connected to the conductor elements on the upper side of the cover part. The cover part incorporates a lateral extension, which is configured as a laterally-projecting plug-in connector, the pins of which are connected both to the conductor elements and to a circuit board. At one free end of the rotor shaft, a signal generator is arranged for the detection of the rotor position. In axial opposition to the signal generator, a circuit board is arranged, upon which a sensor element for the evaluation of signals is arranged, which is not represented in greater detail. A metal cover with cooling ribs is fitted to the plastic cover part by means of clamping elements.

A design of this type has a disadvantage in that, as a result of the lateral projection of the plug-in connector, the electrical machine occupies a large structural volume in the radial direction. The axial mounting of the circuit board in the plastic cover part, with the plug-in connector, does not permit any central axial connector outlet.

### SUMMARY OF THE INVENTION

The device according to the invention and the method according to the invention, have the advantage in that, by the provision of a sealing ring, the plug-in connector can be reliably sealed in relation to the cut-out in the metal cover. In this manner, the connector outlet of the plug-in connector can be arranged on the axial cover surface of the metal cover, as a result of which the electrical machine, with no radial projections, can be employed in a relatively narrow cylindrical structural volume. Particularly advantageously, the cut-out in the metal cover is configured to a circular design, and is punched out of the metal cover in axial opposition to the rotor. This circular cut-out can be particularly advantageously sealed in relation to the plug housing by means of a sealing ring.

By means of the measures described in the dependent claims, advantageous further developments and improvements of the forms of embodiment disclosed in the independent claims are possible. The plug housing is advantageously formed of plastic, and incorporates the plug-in connector in the form of an axial projection. The plug pins are directly embedded as insert components during the injection-molding of the plug housing. The plug housing comprises a cylindrical circumferential wall, which is advantageously mounted axially to the open pole pot. The electrical contacts of the plug pins are arranged within the cylindrical circumferential wall. The outer side of the circumferential wall constitutes a radial sealing surface, to which the sealing ring can be fitted.

In order to permit the exact positioning of the sealing ring on the plug housing, an axial shoulder is molded onto the circumferential wall, with which the sealing ring engages axially. This arrangement also prevents any axial displacement or twisting of the sealing ring upon the fitting of the metal cover to the plug housing. Additionally, this axial bearing surface can simultaneously be configured as an axial sealing surface, such that the plug housing comprises both a radial and an axial sealing surface for the sealing ring.

For the constitution of a radial seal, a radial inner side of the metal cover compresses the sealing ring radially against the radial sealing surface of the plug housing. The metal cover can be cost-effectively configured as a deep-drawn part, the cylindrical inner side of which is directly configured as a radial mating sealing surface for the radial sealing ring.

For the achievement of an axial seal, the metal cover comprises a cover surface, which extends transversely to the rotor shaft, the inner side of which is configured as an axial bearing surface for the sealing ring. If the metal cover is axially attached to the plug housing, the annular axial inner surface of the metal cover can constitute an axial seal with the opposing axial shoulder of the plug housing and the intervening sealing ring.

The plug housing, on its axial upper side, comprises a base surface, onto which the plug-in connector is molded. This base is particularly advantageously configured to a circular design, and the radial circumferential side thereof engages with the inner radial edge of the circular cut-out in the metal cover. The sealing ring is thus reliably shielded by the annular cover surface of the metal cover, such that the sealing ring is not directly exposed to the impact of any water stream. In this manner, the plug housing can be reliably sealed in relation to the metal cover.

By the arrangement of the sealing ring in the axial upper region of the circumferential wall of the plug housing, radial cut-outs in the circumferential wall, which are arranged axially below the radial sealing surface, can also be reliably sealed. Thus, for example, radial windows can be molded into the circumferential wall for the execution of welded joints in the interior of the plug housing. By this arrangement, the electrical contacts of the plug pins can be electrically connected to the corresponding terminal pins or ground contacts of the stator, after the plug housing has already been fitted to the pole pot. As the metal cover is directly axially sealed in relation to the pole pot, no moisture can reach the entire axial lower region below the radial sealing surface of the plug housing.

Additionally to the axial shoulder for the sealing ring, a further axial bearing surface can be configured on the outer circumferential wall of the plug housing, to which an axial spring can be applied which exerts an axial tensioning force between the plug housing and the metal cover. To this end, a corresponding and axially opposing mating bearing surface is configured on the inner side of the metal cover. After the fastening of the metal cover to the pole pot, this socket-shaped spring continuously compresses the plug housing against the flange of the pole pot, in order to offset manufacturing tolerances and differential material expansions in the various components over a wide temperature range.

In the interests of an axially favorable assembly sequence for the electrical machine, the radial dimensions of the plug-in connector, with its associated base, are smaller than the clear span of the cut-out in the metal cover. As a result, the metal cover can be axially attached to the plug housing, directly above the plug-in connector. This applies specifically in the case where, although the electrical contacts on the base are routed axially upwards, the connector shroud is bent through a right angle, such that the plug pins extend in a radial direction. By this arrangement, a customer plug can be radially connected to the electrical machine, without the necessity for an additional radial structural volume to accommodate a plug-in connector configured as a radial projection from the electrical machine.

In order to achieve a reliable sealing action, the sealing ring comprises a plurality of sealing lips, in an axially adjacent arrangement to one another. It is particularly beneficial if at least two sealing lips respectively are arranged on the sealing ring, in both radially opposing directions. By the configuration of the radial seal, the interior space of the motor thus remains reliably sealed even if, on the grounds of vibrations or temperature expansions, the plug housing is subject to axial displacement in relation to the metal cover, within certain limits. Additionally, on one or both axial sides of the sealing ring, axial sealing lips are arranged which, additionally to the radial seal, provide an axial seal.

By the configuration of a plurality of sealing lips on one side of the sealing ring, “pressure-relief chambers” are constituted between the sealing lips which, in the event of the penetration of moisture or impurities, provide a barrier for the next sealing lip.

If the metal cover, over its entire circumference, is welded to the flange of the pole pot by means of a weld seam, a highly robust metal housing, incorporating the plug-in connector, is constituted down to the base, which is firstly of a vibration-resistant design, and secondly functions as electromagnetic shielding. If a radial step is configured on the cylindrical circumferential wall of the metal cover, the resulting axial bearing surface on the inner side of the metal cover can be employed as an axial support for the axial spring. Thus, by the production of the metal cover, the radial and, where applicable, the axial sealing surface for the sealing ring can simultaneously be constituted and, at the same time, the radial structural volume for the socket-shaped tubular spring can be provided between the circumferential wall of the plug housing and the inner side of the metal cover.

It is particularly advantageous if sensor pins are molded into the plug housing, which are connected to a sensor element which is arranged on the inner side of the plug housing. If a free end of the rotor shaft projects through the bearing plate into the interior of the plug housing, a signal generator can be fastened to the rotor shaft, the signals of which can be employed for the evaluation of the detection of the rotor position by the sensor element. A sensor arrangement of this type, without the use of a circuit board as a carrier, can also be employed, even in the event of very high temperatures and vibrations.

Advantageously, the plug housing engages directly with the flange of the pole pot. Thus, by the connection of the metal cover to the flange, the plug housing is axially compressed against the flange, by means of the metal cover. Particularly advantageously, the cylindrical inner wall of the metal cover is thus directly sealed in relation to the plug housing, by means of the sealing ring. In this embodiment, the bearing plate is radially fastened to the pole pot within the plug housing, independently of said plug housing.

By the production method according to the invention, both the stator, incorporating the bearing plate, and the plug housing can each be manufactured as prefabricated units, which are then axially fastened one inside the other. Accordingly, the electrical contacts can then be electrically connected to the corresponding mating contacts within the housing. Thus, all the electrical contacts, with the corresponding mating contacts, are arranged radially within the circumferential wall of the plug housing, and radially within the external diameter of the pole pot, such that the electrical machine assumes a slim cylindrical structural form, with no radial projections. Further to the completion of electrical connections, a metal housing can be fitted to the plug housing, which is sealed both with respect to the pole pot and with respect to the plug-in connector, which projects outwards through the axial cut-out in the metal housing. To this end, the sealing ring can be fitted to the plug housing on the radial outer sealing surface, onto which the inner side of the metal housing is then fitted to constitute a radial seal. As a result, the circular cut-out in the metal cover is reliably sealed, by means of the sealing ring, over a wide temperature range. The radial side wall of the metal housing entirely encloses the plug housing, and is welded to the pole pot over its entire circumference in a leak-tight manner. A weld seam of this type can be highly advantageously applied between the flange of the pole pot and the axial lower edge of the metal cover.

By this production method, the plug housing can be fully populated in advance with all electrical and electronic components, and the latter can be mutually electrically interconnected whereby, advantageously, electrical conductors can be molded into the plug housing in the form of insert components. If the rotary position sensor and corresponding interference suppression components are fastened directly to the inner wall of the plug housing, without the use of a circuit board, these electronic components can be employed even at very high ambient temperatures. By the axial tensioning of the plug housing in relation to the metal cover, by means of the tubular spring, differential material expansions can be compensated.

### BRIEF DESCRIPTION OF THE DRAWINGS

Exemplary embodiments of the invention are represented in the drawings, and are described in greater detail in the following description. In the drawings:

FIG. 1 shows a sectional view of a first exemplary embodiment of an electrical machine according to the invention,

FIG. 2 shows a view according to FIG. 1, prior to the fitting of the metal cover,

FIG. 3 shows a view according to FIG. 1, after the fitting of the metal cover,

FIG. 4 shows a cross-sectional view of the sealing ring, in the unloaded state,

FIG. 5 shows a cross-sectional view of the sealing ring, in the installed state,

FIG. 6 shows a further exemplary embodiment according to the invention.

### DETAILED DESCRIPTION

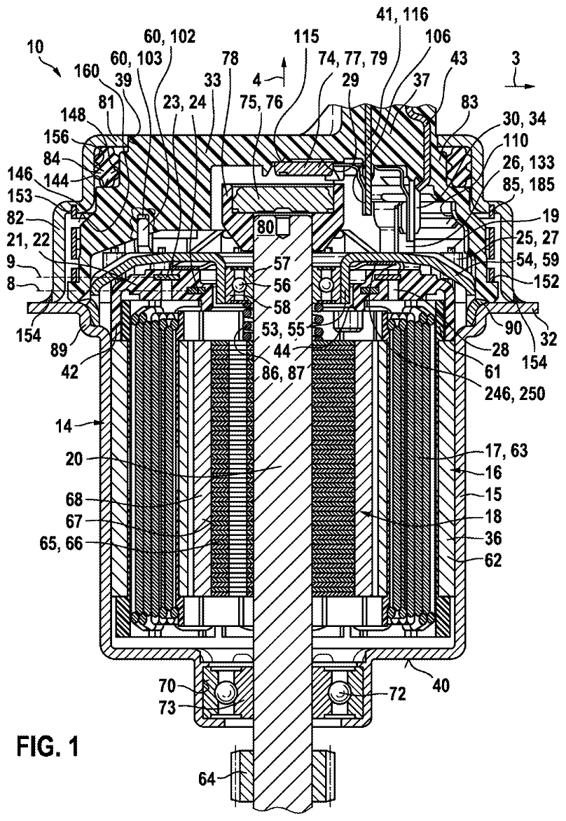

FIG. 1 shows an exemplary embodiment of a fully-assembled electrical machine 10, in which a stator 16 is fitted in a housing 14 of an electrical machine 10. The stator 16 comprises coil frames 36, which are constituted, for example, of separate individual segments 62 and wound with electrical windings 17. The housing 14 functions as a pole pot 15, which constitutes a magnetic return path for the electrical windings 17. The pole pot 15, at its open end, incorporates a flange 32, upon which further components are fitted. In the exemplary embodiment according to FIG. 1, the pole pot 15, on its base surface 40, incorporates an opening, through which a rotor shaft 20 projects, in order to transmit the torque of the electrical machine 10 via a drive element 64 to an unrepresented gearing element. On the base surface 40, a first bearing seat 70 is molded, into which a first rolling bearing 72 is inserted. The inner ring 73 of the first rolling bearing 72 is securely attached to the rotor shaft 20. The first rolling bearing 72 thus constitutes a locating bearing for the rotor 18. The rotor 18 comprises a rotor body 65, which carries permanent magnets 68 which interact with the electrical windings 17. The rotor body 65 is comprised, for example, of individually stacked segmental plates 66, in which cut-outs 67 are punched out for the permanent magnets 68. The coil wire ends 19 of the windings 17 project above the electrical coils 63 in the axial direction 4. An interconnection board 22 is axially mounted on the stator 16, wherein conductor elements 23 which project from a plastic body 21 are bonded, on fastening sections 25, to the coil wire of the coils 63. Electrical connections between the coil wire and the fastening sections 25 are constituted, for example, by welding, soldering or crimping. In the exemplary embodiment described, exactly three conductor elements 23 respectively comprise a terminal pin 26 for the phases U, V and W. The plastic body 21 engages in the axial direction 4 with the stator 16, by means of molded-on spacers 42. The spacers 42 of the interconnection board 22 are molded onto the outer radial edge thereof. In the exemplary embodiment, the spacers 42 engage with the coil frame elements 36, on which the electrical windings 17 are wound. In this case, the coil frame elements 36 are configured as individual segments 62 for each coil 63. On each of the coil frame elements 36, an insulating mask 61 for the electrical windings 17 is respectively arranged. The plastic body 21 is configured to an annular design, such that the rotor shaft 20 of the rotor 18 can project through a central cut-out 44 therein.

A bearing plate 54 is arranged axially above the interconnection board 22, the outer radial edge of which is welded to the pole pot 15. For example, the bearing plate 54 engages with a cylindrical recess 89 in the flange 32 of the pole pot 15. The bearing plate 54 incorporates a second bearing seat 55, which engages axially with the central cut-out 44 in the interconnection board 22, in the form of an axial projection 53. The second bearing seat 55 accommodates a second rolling bearing 56, by means of which the rotor shaft 20 is supported in the stator 16 in a rotatable manner. The second rolling bearing 56 is configured, for example, as a ball bearing, and constitutes a floating bearing for the rotor 18. To this end, an outer ring 58 of the second rolling bearing 56 is secured in the second bearing seat 55 of the bearing plate 54 in a non-rotating manner. The inner ring 57 is supported on the rotor shaft 20 in an axially displaceable manner. The second rolling bearing 56 is thus axially arranged in the same plane as the interconnection board 22, such that the electrical machine 10, in the axial direction 4, shows a highly compact design. In the exemplary embodiment, the bearing plate 54 incorporates individual radial webbings 59, between which the fastening sections 25, which are configured as receiving bushes 27, project axially upwards. Coil wire ends 19 of the coils 63 are inserted in perforations in the receiving bushes 27. The terminal pins 26 likewise extend from the plastic body 21 through the bearing plate 54, in order to permit the bonding thereof to corresponding contacts 30 of the plug-in connector 37. In the sectional representation of the plastic body 21, connecting sections 24 of various conductor elements 23 can be seen in cross-section. The cross-sections, which are shown in a flattened representation, are arranged in a mutually offset manner, both with respect to the axial direction 4 and with respect to the radial direction 3. Consequently, for example, four individual conductor elements 23 can be arranged in exactly two axial planes 8, 9. In the cross-sectional representation, axial ducts 28 in the plastic body 21 can be seen, which originate from retaining tools for the conductor elements 23 which are arranged in the injection-molding tool. For the purposes of vibration damping, the interconnection board 22 is compressed axially downwards from the bearing plate 54 against the coil frame 36 by means of axial spring means 246. The spring means 246 are configured, for example in the form of an axial spring washer, which encloses the rotor shaft 20. The spring washer is preferably configured as a corrugated disk 250, which engages axially with the bearing plate 54 and with the interconnection board 22. The spring means 246 generate an axial tensioning force, which maintains the interconnection board 22 in an exact position, even over a wide temperature range and in the event of high vibratory loads. The rotor 18 is axially tensioned with respect to the second rolling bearing 56 by means of a compression spring 86. The compression spring 86—for example, a helical spring 87—engages on one side with the rotor body 65, and on the other side with the inner ring 57 of the second rolling bearing 56.

Axially above the bearing plate 54, a plug housing 33 is arranged, upon which an external plug-in connector 37, which is not represented in greater detail, is arranged for the supply of electric power to the electrical machine 10. In the plug housing 33, on the inner side 29 thereof, electrical contacts 30 are arranged, which are connected to the terminal pins 26 of the interconnection board 22. The interconnection board 22 is connected to both the coil wire ends 19 and to the electrical contacts 30 of the plug-in connector 37. For example, the electrical contacts 30 extend axially downwards in the form of contact lugs 34, such that they are arranged immediately adjacently to the terminal pins 26, and can then, for example, be welded to one another. In order to ensure the correct positioning of the terminal pins 26 in the circumferential direction 2, the interconnection board 22 incorporates positioning elements 60, both with respect to the stator 16 and/or with respect to the bearing plate 54, which cooperate with corresponding mating elements. The plug housing 33 is likewise positioned with respect to the bearing plate 54 by means of an anti-rotation mechanism 102, 103. In the plug housing 33, a sensor element 74 is fastened, which cooperates with a signal generator 75 on the rotor shaft 20, in order to detect the rotor position thereof. The sensor element 74 is, for example, permanently adhered to a flat base surface 115 of a sensor housing 79 on the inner side 29 of the plug housing 33. For the purposes of rotary position detection, further to the fitting of the bearing plate 54, a magnet holder 78 is press-fitted to the free end 80 of the rotor shaft 20, which accommodates a sensor magnet 76. The rotating magnetic field thereof is detected by the sensor element 74, which is configured as a high-resolution magnetic field sensor 77. A metal cover 81 is attached above the plug housing 33, which is welded to the flange 32 of the pole pot 15 in a leak-tight manner, by means of the weld seam 154. Both the plug housing 33 and the metal cover 81 each comprise a circular circumferential wall 82, 83, which are arranged radially adjacently to each other. Between the plug housing 33 and the inner side of the metal cover 81, a radial sealing ring 84 is press-fitted, which seals the electrical machine 10 in relation to the plug-in connector 37. Moreover, an axial spring element 85 is arranged between the plug housing 33 and the metal cover 81, which axially compresses the plug housing 33 against the flange 32 of the pole pot 15.

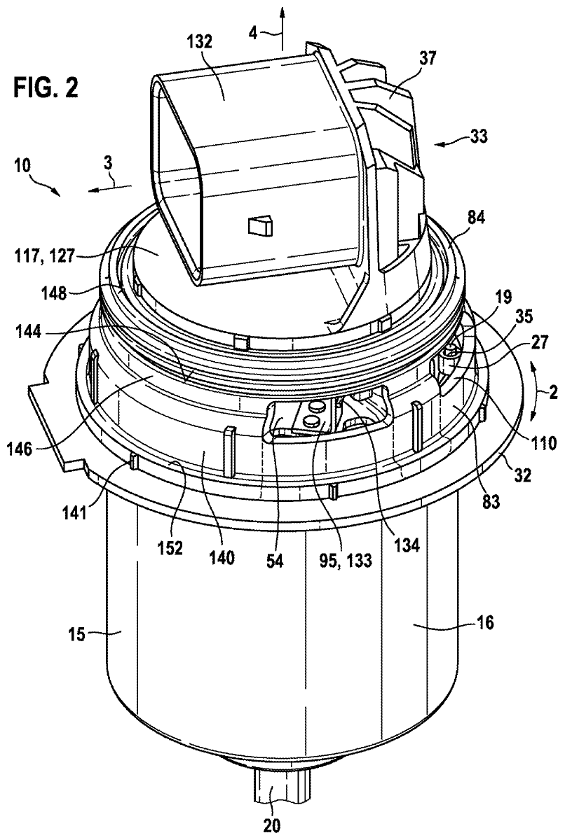

FIG. 2 shows an electrical machine 10, in which the plug housing 33 has been fitted to the pole pot 15, prior to the attachment of the metal cover 81 above the plug housing 33. The plug housing 33, on the open end thereof to the pole pot 15, incorporates an edge 140 which is enclosed over the entire circumference thereof. From the lower edge 140 of the plug housing, which engages axially with the pole pot 15, the circumferential wall 83 extends in the axial direction 4, in which radial windows 110 are formed for the insertion of welding tools. For example, a free capacitor terminal 134 of a capacitor which is fastened in the plug housing 33 is compressed against a ground contact 95 of the bearing plate 54, and is then bonded by welding through the window 110. Further radial windows 110 are arranged adjacently in the circumferential direction 2, through which, by means of welding tools, the terminal pins 26 are welded to the contact lugs 34 of the plug housing 33. The terminal pins 26 extend in the axial direction 4, parallel to the contact lugs 34. The latter overlap in the axial direction 4, and are arranged adjacently to one another in the circumferential direction 2. During the welding process, the plug housing 33 is axially compressed against the pole pot 15 by an assembly device. In this embodiment, welded joints between the terminal pins 26 and the contact lugs 34, and the welded joint between the ground contact 95 of the bearing plate 54 and the free capacitor terminal 134 can be executed, for example, using an identically configured welding tool. In place of the free second capacitor terminal 134, alternatively, a separate contact spring or an integral spring arm can also be configured on a second contact element for the capacitor, such that the welded joint and the first window 110 for the free capacitor terminal 134 can be omitted. Conversely, the ground contact 95 can then be constituted directly, upon the axial fitting of the plug housing 33 to the pole pot 15, by the sprung contact with the bearing plate 54. In this embodiment, the plug housing 33 then comprises an exact total of only three windows 110 for the welds U, V and W.

In this case, in the axial region of the radial window 110, the circumferential wall 83 of the plug housing 33 incorporates a radial offset 146, in order to constitute an annular axial shoulder 144 for the sealing ring 84. The sealing ring 84 is axially fitted to this annular shoulder 144 such that, over the entire circumference, it engages radially with a cylindrical radial sealing surface 148 of the circumferential wall 83. Axially above the radial sealing surface 148, the circumferential wall 83 forms a transition to an axial cover wall 117 of the plug housing 33, onto which the plug-in connector 37 is molded. A circular base 127 is thus constituted on the cover wall 117, onto which the plug-in connector 37, with its associated penetrations for the plug pins 41, 43, is molded. The transition from the upper cover wall 117 of the plug housing 33 to the plug-in connector 37 is thus entirely radially located within the radial sealing surface 148. The plug-in connector 37 projects out of the metal cover 81 through a cut-out 39 in the axial upper side. In this exemplary embodiment, the power pins 43 and the sensor pins 41 are angled in the radial direction 3, such that a corresponding customer plug is insertable in a connector shroud 132 of the plug-in connector 37, in the radial direction 3. Thus, in the radial direction 3, the plug-in connector 37, in combination with the connector shroud 132, does not project beyond the circular cut-out 39 in the metal cover 81. In an alternative embodiment, the power pins 43 and the sensor pins 41 in the plug-in connector 37 can also extend in the axial direction 4, such that the corresponding customer plug can be fitted from above to the connector shroud 132 in the axial direction 4. On the continuous annular edge 140, an axial rebate 152 is formed on the outer side of the plug housing 33, with which the annular axial spring 85 can engage. The axial spring 85 is configured, for example, as a tubular spring 185, which is axially attached to the plug housing 33 up to the axial rebate 152. In the exemplary embodiment, axially-oriented ribs 141 are molded onto the edge 140, by means of which the metal cover 81 is centered during the press-fitting thereof. In one variation of the embodiment, the windows 110 can also be configured to open axially downwards (represented by broken lines in FIG. 2). The edge 140 is thus no longer configured continuously over the circumference, but incorporates interruptions in the region of the windows 110. Thus, in these regions, the plug housing 33 only engages with axial webbings between the windows 110 on the pole housing 15.

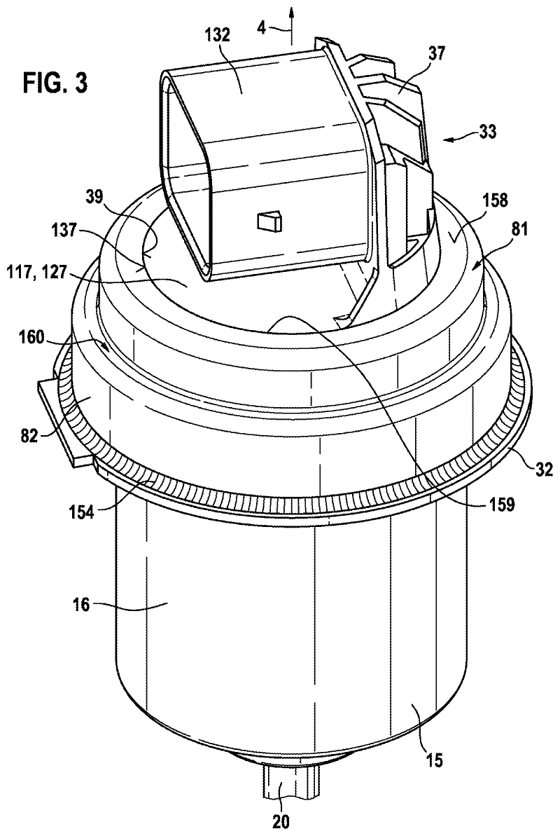

As can be seen in FIG. 3, the metal cover 81 is then fitted axially over the plug housing 33, such that the cylindrical metal wall 82 thereof covers the radial windows 110. The sealing ring 84 seals the radial sealing surface 148 of the plug housing 33 vis-à-vis the radial inner side 156 of the metal cover 81. An annular cover surface 158 of the metal housing 81, which constitutes a rim 159 of the cut-out 39, entirely covers the sealing ring 84 in the axial direction 4. The rim 159 engages radially with a radial lateral surface 137 of the base 127, such that the sealing ring 84 is protected against a direct fluid stream. During the fitting of the metal cover 81, the latter is axially compressed against the flange 32 of the pole housing 15, against the axial spring force of the axial spring 85, and is welded to the flange 32 by means of a fully-circumferential weld seam 154. The tubular spring 185 engages axially on one side with the axial rebate 152 on the plug housing 33, and on the other side with an axial counter-stop 153 in the metal housing 81. To this end, a radial step 160 is formed in the cylindrical metal wall 82 of the metal cover 81, which constitutes an annular axial shoulder in the form of an axial counter-stop 153.

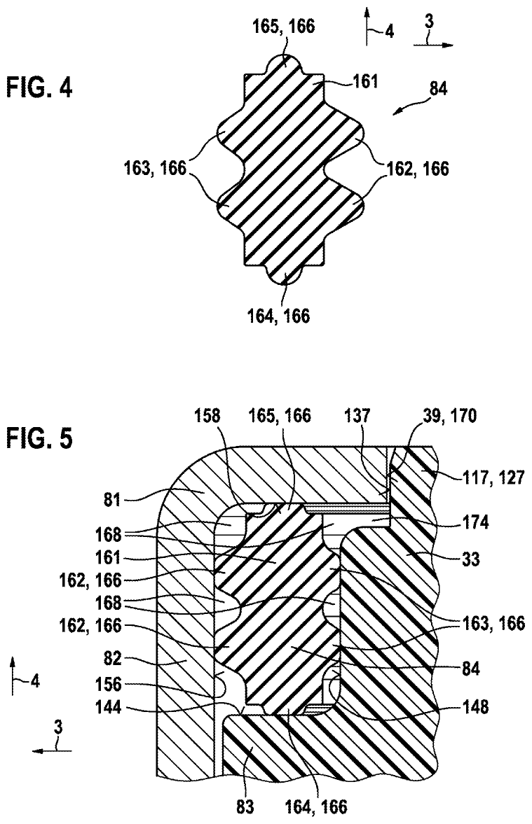

FIG. 4 shows a cross-sectional representation of a sealing ring 84 according to the invention which is formed, for example, of silicone or an elastomer. In this embodiment, the cross-section comprises a rectangular base shape 161, which extends further in the axial direction 4 than in the radial direction 3. On the right-hand side, two axially-adjoining radial sealing lips 162 are configured which, in the installed state, engage radially with the inner side 156 of the metal housing 81. In radial opposition thereto on the rectangular base shape 161, two further radial sealing lips 163 are configured, which extend radially inwards to the radial sealing surface 148 of the plug housing 33. The radially outwardly-oriented sealing lips 162, which engage with the metal housing 81, are configured to larger dimensions, and specifically incorporate a larger radial extension than the radially inwardly-oriented sealing lips 163. On the rectangular base shape 161, moreover, an axial sealing lip 164 is formed, which extends axially downwards to the annular shoulder 144 of the plug housing 33. In the axially opposing direction, a further axial sealing lip 165 extends upwards towards the annular cover surface 158 of the metal housing 81.

A sealing ring 84 according to FIG. 4 is represented, in the installed state, in FIG. 5. Upon installation, all the sealing lips 166 undergo deformation, such that the sealing lips 166 engage with their respective opposing sealing surfaces 148, 156, 144, 158 in a sealing manner. In the radial direction 3, greater compression occurs between the radial sealing surface 148 and the inner side 156 than in the axial direction 4 between the annular shoulder 144 and the annular cover surface 158. This is attributable to the fact that, in the event of high temperature differences, axial displacement occurs between the plug housing 33 and the metal housing 81, which is compensated by the axial spring 85. Consequently, an axial clearance 174 is constituted between the plug housing 33 and the metal housing 81, which permits an axial movement of the plug housing 33 relative to the metal housing 81. However, the sealing action of the axial seal is thus strongly dependent upon temperature variations. The radial seal constituted by the radial sealing lips 162 and 163, however, is substantially independent of temperature, as no significant radial relative movement occurs between the plug housing 33 and the metal housing 81. Between the sealing lips 166, in the installed state, cavities 168 are constituted, into which the material of the sealing ring 84 can expand. The cavities 168 also function as pressure-relief chambers for the seal, in which dirt particles and moisture can accumulate. The pressure-relief chambers thus prevent any “infiltration” of the sealing lips 166, which can specifically occur on sealing lips 162, 165 which engage with a sealing surface 156, 158 of metal construction. The metal housing 81 of the device represented in FIG. 5 is radially centered by the press-fitting thereof onto the sealing ring 84 wherein, simultaneously, the sidewall 170 of the cut-out 39 engages radially with the radial lateral surface 137 of the base 127.

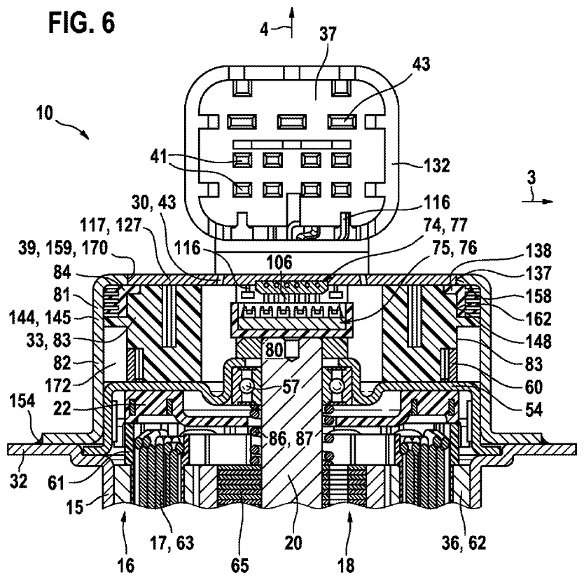

A further exemplary embodiment of a fully-assembled electrical machine 10 is represented in FIG. 6. The plug-in connector 37 is arranged axially above the cover wall 117, on the outer side of the plug housing 33. The plug-in connector 37 is angled through a right-angle in the radial direction 3, such that the power pins 41 and the sensor pins 43 are likewise oriented in the radial direction 3 within the connector shroud 132. The power pins 43, on the inner side 29, terminate in the form of contact lugs 34, which are welded to the terminal pins 26 on the interconnection board 22. The sensor pins 41, on the inner side 29, terminate in the form of insert conductors 116, which are electrically contacted with terminal lugs 106 on the sensor element 74, which is configured as a magnetic field sensor 77. The sensor pins 41 and the power pins 43 are respectively configured as one-piece bent stampings 116—preferably of copper—which are inserted in the molding tool in conjunction with the injection-molding of the plug housing 33. Further to the fitting of the plug housing 33 to the bearing plate 54 by means of the positioning elements 60, a metal cover 81 is attached over the plug housing 33, which is then fastened to the pole pot 15. The metal cover 81 comprises a cylindrical sidewall 82, which encloses the plug housing 33 over the entire circumference thereof. The sealing ring 84, incorporating a plurality of radial sealing lips 162, is arranged radially between the circumferential wall 82 of the metal cover 81 and the radial sealing surface 148 of the plug housing 33. For example, exactly four axially-adjoining radial sealing lips 162 are formed on the radial sealing ring 84, which engage with the inner side 156 of the sidewall 82. The sealing ring 84 engages axially with the annular shoulder 144 which, in this case, is configured as a radial webbing 145 on the outer side of the circumferential wall 83. On the axial upper side, the sealing ring 84 engages axially with the inner side of the annular cover surface 158 of the metal cover 81. By means of a circumferential radial projection 138, the sealing ring 84 projects radially below the base 127, such that the gap between the lateral surface 137 of the base 127 and the radial inner side of the border 170 is sealed. The plug-in connector 37 projects out of the metal cover 81, through the cut-out 39 which is formed on the axial side of said metal cover 81. By means of the sealing ring 84, the plug-in connector 27 is sealed vis-à-vis the metal cover 81. The metal cover 81, conversely, is welded to the flange 32 of the pole pot 15 in a leak-tight manner. The magnetic field sensor 77 is arranged in the center of the cover wall 117, in direct axial opposition to the sensor magnets 76 which are attached at the free end 80 of the rotor shaft 20. In this embodiment, no axial spring is arranged between the metal cover 81 and the plug housing 33, such that a radial clear space 172 is constituted between the cylindrical sidewall 82 and the circumferential wall 83.

In the method for producing an electrical machine 10 according to the invention, the stator 16 is firstly fitted in the pole pot 15. To this end, the coil frames 36, configured of individual segments 62, are fitted with an insulating mask 61 and are wound with electrical windings 17, prior to the insertion thereof into the pole housing 15. Thereafter, the rotor 18 is inserted axially into the pole pot 15, such that the rotor shaft 20 is securely press-fitted into the first rolling bearing 72. Thereafter, the interconnection board 22 is arranged axially on the coils 63, and is electrically bonded to the coil wire ends 19, preferably by welding. Thereafter, the compression spring 86—specifically a helical spring 87—is axially attached to the rotor body 65 wherein, by the fitting of the bearing plate 54, the compression spring 86 is axially pre-tensioned by the inner ring 57. Simultaneously, the bearing plate 54 is axially tensioned vis-à-vis the interconnection board 22 by means of the axial spring means 246. Under the action of this tensioning, the bearing plate 54, at the radial outer ends thereof, is welded to the pole pot 15. The first centering lug of the bearing plate 54 engages with corresponding mating elements in the interconnection board 22. Further to the attachment of the bearing plate 54 by welding, the rotor 18 is reliably supported in the pole pot 15, both radially and axially, in an oscillation-damping manner. In this state, the terminal pins 26 and the second centering lug 102 project axially upwards, such that the plug housing 33, with its associated mating element 103, can be axially attached to the centering lug 102. The plug housing 33 thus engages axially with the flange 32 of the pole pot 15. Through the radial windows 110 in the plug housing 33, the terminal pins 26 can be welded to the electrical contacts 30 of the plug housing 33. Likewise, the interference suppression capacitor of the plug housing 33 can be welded to the ground contact 95 on the bearing plate 54, or the contact spring can be compressed against the bearing plate 54. Thereafter, the sealing ring 84 is attached to the radial sealing surface 148 of the plug housing 33. Upon the fitting of the metal cover 81, the sealing ring 84 is compressed between the metal cover 81 and the plug housing 33, wherein at least one radial seal and, where applicable, also one axial seal are configured. The metal cover 81 in turn engages with the flange 32 and, over the entire circumference thereof, is welded to the pole pot 15 in a leak-tight manner. By this arrangement, the axially upwardly projecting plug-in connector 37, above the base 127 thereof, is reliably sealed in relation to the border 159 of the cut-out 39 in the metal housing 81. In order to offset differential material expansions of the individual components over a wide temperature range, an axial spring 85 is preferably tensioned between the metal cover 81 and the plug housing 33, which axially compresses the plug housing 33 against the pole pot 15.

It will be observed that, with respect to the exemplary embodiments represented in the figures and in the description, multiple mutual combinations of the individual characteristics are possible. Thus, for example, the number, the physical configuration and the arrangement of the sealing lips 166, and of the opposing sealing surfaces 148, 156, 144 158, can be varied. Optionally, an axial seal can be configured in addition to the radial seal. Likewise, the position and the configuration of the plug-in connector 37, with its associated base 127, the contact lugs 34 and the insert conductors 116 can be adapted in accordance with customer requirements for the plug housing 33. The electrical machine 10 is preferably intended for application in a gearing and drive unit as an engine compartment actuator in a vehicle, for example for the actuation of moving parts or the operation of pumps in the engine compartment, but is not restricted to such applications.

1. An electrical machine (10), comprising a pole pot (15), in which a stator (16) and a rotor (18) are accommodated, and wherein a plug housing (33) having an integrated plug-in connector (37) is arranged axially on an open end of the pole pot (15), characterized in that the plug housing (33) is enclosed by a metal cover (81) over an entire circumference of the plug housing, the metal cover being connected to the pole pot (15) in a leak-tight manner, wherein the plug-in connector (37) projects outwards through a cut-out (39) in the metal cover (81), in a direction axially opposing the rotor (18), and the plug housing (33) is radially sealed in relation to the metal cover (81) by a sealing ring (84).

2. The electrical machine as claimed in claim 1, characterized in that the plug housing (33) is formed of plastic and comprises a cylindrical circumferential wall (83), upon which a radial sealing surface (148) for the sealing ring (84) is configured.

3. The electrical machine as claimed in claim 1, characterized in that the pole pot (15), at the open end, incorporates a flange (32), with which both the circumferential wall (83) of the plug housing (33) and the metal cover (81) engage axially.

4. The electrical machine as claimed in claim 1, characterized in that a radial inner side (156) of the cylindrical sidewall (82) of the metal cover (81) is configured as a mating radial sealing surface (156), with which the sealing ring (84) engages directly in a radial direction.

5. The electrical machine (10) as claimed in claim 1, characterized in that the metal cover (81), in axial opposition to the axial bearing surface (144) of the plug housing (33), comprises an inner annular cover surface (158), by way of an axial sealing surface, with which the sealing ring (84) engages axially.

6. The electrical machine (10) as claimed in claim 1, characterized in that the cut-out (39) in the metal cover (81) is circular and is directly bordered by the annular cover surface (158) of the metal cover (81), and wherein the plug housing (33), together with a round base (127) of the plug-in connector (37), engages radially with the radial lateral surface (137) of the cut-out (39).

7. The electrical machine (10) as claimed in claim 2, characterized in that, axially below the radial sealing surface (148), radial windows (110) are formed in the circumferential wall (83), through which, further to the fitting of the plug housing (33) to the pole pot (15), electrical contacts (30) of the plug housing (33) are electrically connected to electrical mating contacts (133) on the stator (16).

8. The electrical machine (10) as claimed in claim 2, characterized in that, on the circumferential wall (83), an axial rebate (152) is configured for an annular spring element (85, 185), which compresses the plug housing (33) axially against the pole pot (15).

9. The electrical machine (10) as claimed in claim 1, characterized in that the maximum radial dimensions of the plug-in connector (37), in the fully-assembled state, extend radially within the cut-out (39).

10. The electrical machine (10) as claimed in claim 1, characterized in that the sealing ring (84) assumes an approximately rectangular cross-section (161) from which, in both radial directions (3), a plurality of radial sealing lips (166, 162, 163) project.

11. The electrical machine (10) as claimed in claim 10, characterized in that annular cavities (168) are configured between the sealing lips (166) and the plug housing (33) or the metal cover (81), in order to prevent any infiltration of salt residues via the sealing lips (166).

12. The electrical machine (10) as claimed in claim 8, characterized in that the metal cover (81) is permanently welded to the flange (32), in a leak-tight manner, by a circumferential weld seam (90), and the metal cover (81) compresses the annular spring element (85), by means of an axial counter-stop (153), axially against the rebate (152) in the plug housing (33).

13. The electrical machine (10) as claimed in claim 1, characterized in that a rotor shaft (20) of the rotor (18), at one free end (80) thereof, projects axially outwards from the pole pot (15) through a bearing plate (54) into the plug housing (33) and, at the free end (80) thereof, a signal detector (75) for the detection of the rotary position is arranged, which cooperates with a sensor element (74) which is fastened in axial opposition on the plug housing (33).

14. A method for producing an electrical machine (10) as claimed in claim 1, characterized by the following steps:
Fitting of the stator (16) in the pole pot (15), such that electrical mating contacts (133) of the stator (16) project therefrom,
Fitting of the plug housing (33) to the pole pot (15), such that electrical contacts (30) project into the plug housing (33),
Electrical connection of the electrical contacts (30) to the corresponding electrical mating contacts (133) through radial windows (110) in the plug housing (33),
Fitting of a sealing ring (84) to an outer cylindrical sealing surface (148) of the plug housing (33),
Axial attachment of a metal cover (81) to the plug housing (33), such that a plug-in connector (37) of the plug housing (33) projects axially through a cut-out (39) in the metal cover (81), and
Fastening of the metal cover (81) to the pole pot (15), such that the inner side (156) of the metal cover (81) engages with the sealing ring (84), and the cut-out (39) is sealed in relation to the plug housing (33).

15. The method as claimed in claim 14, characterized by the following steps:
Axial fitting of an annular spring (85) to the outer side of the plug housing (33), prior to the axial attachment of the metal cover (81) to the plug housing (33),
Axial tensioning of the annular spring (85) by means of the axial compression of the metal cover (81) against a flange (32) of the pole pot (15), wherein the metal cover (81), on its corresponding axial surfaces (158, 153), engages axially with both the sealing ring (84) and the annular spring (85), and
Welding of the metal cover (81) to the flange (32) in a leak-tight manner.

16. The electrical machine as claimed in claim 1, characterized in that the plug housing (33) is formed of plastic and comprises a cylindrical circumferential wall (83), upon which a radial sealing surface (148) for the sealing ring (84) is configured, and wherein the circumferential wall (83) incorporates a radial offset (146), such that a first annular axial shoulder (144) is constituted, which functions as an axial sealing surface (144) for the sealing ring (84).

17. The electrical machine (10) as claimed in claim 1, characterized in that the metal cover (81), in axial opposition to the axial bearing surface (144) of the plug housing (33), comprises an inner annular cover surface (158), by way of an axial sealing surface, with which the sealing ring (84) engages axially, wherein the sealing ring (84) has a diameter which approximately corresponds to the diameter of the cylindrical sidewall of the pole pot (15).

18. The electrical machine (10) as claimed in claim 2, characterized in that, axially below the radial sealing surface (148), radial windows (110) are formed in the circumferential wall (83), through which, further to the fitting of the plug housing (33) to the pole pot (15), power pins (43) of the plug housing (33) are electrically connected to terminal pins (26) of coils (63) on the stator (16) by welding.

19. The electrical machine (10) as claimed in claim 2, characterized in that, on the circumferential wall (83), a second annular axial shoulder is configured for an annular spring element (85, 185), which compresses the plug housing (33) axially against the pole pot (15).

20. The electrical machine (10) as claimed in claim 18, characterized in that the maximum radial dimensions of the plug-in connector (37), in the fully-assembled state, extend radially within the cut-out (39) wherein the power pins (43) extend in a radial direction (3) in a connector shroud (132) of the plug-in connector (37).

21. The electrical machine (10) as claimed in claim 1, characterized in that the sealing ring (84) assumes an approximately rectangular cross-section (161) from which, in both radial directions (3), a plurality of radial sealing lips (166, 162, 163) project, and axial sealing lips (166, 164, 165) are also formed in the axial direction (4).

22. The electrical machine (10) as claimed in claim 8, characterized in that the metal cover (81) is permanently welded to the flange (32), in a leak-tight manner, by a circumferential weld seam (90), and the metal cover (81) compresses the annular spring element (85), by means of an axial counter-stop (153), axially against the rebate (152) in the plug housing (33), and in that the metal cover (81) incorporates a radial step (160), which constitutes the axial counter-stop (153) and connects two concentric cylinder walls of the circumferential wall (82) of the metal cover (81).

23. The electrical machine (10) as claimed in claim 1, characterized in that a rotor shaft (20) of the rotor (18), at one free end (80) thereof, projects axially outwards from the pole pot (15) through a bearing plate (54) into the plug housing (33) and, at the free end (80) thereof, a signal detector (75) for the detection of the rotary position is arranged, which cooperates with a sensor element (74) which is fastened in axial opposition on the plug housing (33), and wherein the sensor element (74) is directly connected to sensor pins (41) of the plug-in connector (37) which are molded into the plug housing (33).
